(19) United States
(12) Patent Application Publication
(10) Pub. No.: US 2001/0012992 A1
(43) Pub. Date: Aug. 9, 2001

(54) Apparatus, method and recording medium for translating documents

(76) Inventors: Kyoko Kimpara, Tokyo (JP); Mitsugu Miura, Tokyo (JP)

Correspondence Address: FOLEY & LARDNER, Washington Harbour, 3000 K Street, N.W., Suite 500, P.O. Box 25696, Washington, DC, 20007-8696, US

(21) Appl. No.: 09/739,801

(22) Filed: Dec. 20, 2000

(30) Foreign Application Priority Data
Dec. 21, 1999 (JP) 11-363352

(51) Int. Cl. G06F 17/28

(52) U.S. Cl. 704/5; 704/2; 704/7

(57) ABSTRACT

A translation server system is to be provided, which enables, where information is to be sent from a recipient, the recipient and the provider to transmit and receive the information in their respective native languages, troublesome work on the part of the recipient to be minimized, and the communication cost to be saved by restraining unnecessary communication. In a translation server system for translating a hyperlink document prepared in the source language and supplying the result of translation to a terminal apparatus 20 having accessed the hyperlink document, a translation unit 14, when input target language translating instruction information F2 is supplied from the terminal apparatus 20, translates the input target language into the input source language.

### BACKGROUND OF THE INVENTION

1. Field of the Invention

The present invention relates to an apparatus, a method and storage medium for translating documents, and more particularly to an apparatus, a method and storage medium for translating documents associated with other documents by locational information (hereinafter to be referred to as hyperlink documents). In this specification, this apparatus will be referred to as a translation server.

2. Description of the Related Art

In recent years, along with the dramatic improvement in computerized processing by personal computers (PCs) and work stations among others together with the development of networks including the Internet, various digitized information is transmitted and received by computerized communication. Further, the enhanced processing capacity of computers has led to the advent of operating systems (OS) whose communication environment is well developed and, at the same time, browsing programs known as browsers, which operate on such an OS and are claimed to facilitate access to information, are offered at low prices or even free of charge. Over the networks, especially the Internet, various information is distributed across national borders. This is no less true of document data, whose contents are basically accessible by anybody in the world as they are distributed over the Internet.

On the Internet, companies, universities and others are presenting their respective home pages, which are written in either English or the respective official languages of the countries to which the presenting parties belong. The aforementioned browsers also facilitate access to these home pages, but if a user whose native language is not English accesses a home page written in English he would find it impossible to understand its contents either at all or at least immediately. Such a language barrier should be lowered as much as practicable in order to vitalize cultural or economic exchanges through the transmission and reception of information. This necessitates a translation apparatus.

FIG. 16 is a block diagram illustrating the configuration of a translation server system according to the prior art. The conventional translation server system is configured of a translation server 100, a terminal apparatus 200, such as a PC, operated by the user and a server apparatus 300 in which hyperlink documents are stored, all connected via a network. The translation server 100 consists of a data acquisition unit 110, an information separating unit 120, a translation unit 130 and an information synthesizing unit 140. A translating instruction application program 210 to instruct the translation server 100 to translate a document designated by locational information F100 is built into the terminal apparatus 200. Such an application program to realize the translating instruction application program 210 is usually realized with a browser built into the terminal apparatus 200.

The translation server system illustrated in FIG. 16 operates as described below.

First the user designates to the browser built into the terminal apparatus 200 the URL of the translation server 100, and establishes connection to the translation server 100. Upon establishment of connection to the translation server 100, an input dialog box for entering the URL to be accessed is displayed on the terminal apparatus 200. The user designates in this input dialog box the URL to be accessed. The URL entered from the input dialog box is transmitted as locational information F100 to the data acquisition unit 110 of the server apparatus 100.

Next, as the user gives a translating instruction to the browser, which is the translating instruction application program 210, translating instruction F100 is transmitted from the terminal apparatus 200 to the server apparatus 100. Upon receiving the locational information F100, the data acquisition unit 110 accesses the server apparatus 300 designated by this locational information F100, and acquires necessary information. Then, upon acquiring necessary information from the server apparatus 3O0, the data acquisition unit 110 stores that information into a cache memory. Upon receiving this translating instruction F100, the data acquisition unit 110 supplies the contents stored in the cache memory to the information separating unit 120. The information separating unit 120 separates the information supplied from the data acquisition unit 110 into a text T100 and a non-text part T110, supplies the text T100 to the translation unit 130 and the non-text part T110 to the information synthesizing unit 14. The translation unit 130 processes the translation of the text T100 supplied from the information separating unit 120. For instance, if the text T100 is prepared in English, it is translated into Japanese and supplied to the information synthesizing unit 140.

The information synthesizing unit 140 synthesizes the translated text supplied from the translation unit 130 and the non-text part T110 supplied from the information separating unit 120, and supplies the synthesized information to the terminal apparatus 200 accessing the translation server 100. Generally, as a hyperlink document is diversely linked, and the user wishing to view the contents of the destination of any such link on the browser has to enter again the URL of the destination to the browser, and transmit it to the server apparatus 100 as locational information F100. If the contents need to be translated, a translating instruction F100 will have to be transmitted to the server apparatus 100.

Incidentally on the Internet, not only the provider of information unilaterally transmits information, but also it is sometimes necessary for the recipient of information to transmit an instruction to designate the information he requires to the provider and for the provider to return to the recipient information customized to meet the latter's instruction. Or where the provider requires some personal information on the recipient, some other information than what is supplied from the provider to the recipient may be transmitted from the recipient to the provider. Where such interactive communication of information is to take place between the provider and the recipient and the two parties use different languages, a conventional apparatus would involve problems.

Thus the conventional apparatus, though it can translate information transmitted from the provider by giving a translating instruction to the translation server, it cannot translate information transmitted from the recipient. Therefore where, for instance the recipient's native language is Japanese and the provider's is English, the recipient has to translate for himself the message intended for transmission, and enter the translated message into a browsing program such as a browser. In doing so, if the user knows every word in the message in English, it may take little time, but if there are many words for which he has to consult a dictionary, entering the message in English can be quite troublesome.

Furthermore, with the conventional apparatus, a document prepared in a foreign language (e.g. English) would be displayed in English on the browser, and will be translated into Japanese only after the recipient gives a translating instruction to the translation server. Accordingly, even where entry by the recipient of a message in English results in transmission of a document from the provider, the contents displayed on the browser will inevitably be in English, and translation of the contents would require another translating instruction, which again could be quite troublesome.

Problems that may arise when personal information on the recipient or the like is to be transmitted to the provider include the following. For instance, if a hotel booking form is prepared in English, its contents are translated into Japanese by the translation server and displayed, and each entry in the form is answered in Japanese, the hotel's clerk whose native language is English is unlikely to understand the filled form. Therefore, when entering information into a form prepared in a foreign language, the party who fills the form is obliged to use the language in which the blank form is prepared.

When blanks in a displayed form are being filled, the terminal at which the entry is made is usually on line, and it will be kept on line for a long period of time, and accordingly the communication cost will run up to a large sum, because the entry requires the time to keep the document in a foreign language displayed, that to give an instruction to translate the document, that for the recipient to translate the contents to be entered into the form for himself, and that to enter the translate contents into the form. This is a particularly serious problem for users in today's Japanese environment for communication, where connection to the Internet is usually established by dial-up. It may not seem to be a serious problem where an environment of sustained connection to the Internet is available, but in view of the finiteness of network resources wasteful communication should be eliminated wherever practicable.

### SUMMARY OF THE INVENTION

An object of the present invention is to provide a translation apparatus, a translation method and a storage medium on which a translation program is recorded, for use where a client to an information providing service (hereinafter to be referred to as the recipient) is to transmit information on his part, enabling the recipient and the provider of the service to transmit and receive information in their respective native languages, the recipient to minimize his trouble and the cost of communication to be reduced by restraining unnecessary communication.

According to an aspect of the present invention, there is provided an apparatus for translating documents, comprising: a data acquisition unit for acquiring from a server apparatus a document prepared in a first language; an information separating unit for separating the document acquired by the data acquisition unit into a translation needing portion and a non-translation-needing portion; a translation unit for translating the translation-needing portion obtained by the information separating unit into a second language; an information conversion unit for converting the non-translation-needing portion obtained by the information separating unit, where the portion contains information indicating that any word or phrase is to be delivered to the server apparatus, into aversion of the portion appended with translating instruction information for recognizing the need to translate the word or phrase entered in the second language into the first language; and an information synthesizing unit for synthesizing the result of translation by the translation unit and that of conversion by the information conversion unit and supplying the result of synthesis to a terminal apparatus.

According to another aspect of the present invention, there is provided a method for translating documents, comprising: acquiring a document prepared in a first language from a server apparatus; separating the acquired document into a translation-needing portion and a non-translation-needing portion; translating the translation-needing portion into a second language; converting the non-translation-needing portion, where the portion contains information indicating that any word or phrase is to be delivered to the server apparatus, into a version of the portion appended with translating instruction information for recognizing the need to translate the word or phrase entered in the second language into the first language; and synthesizing the result of translation and that of conversion and supplying the result of synthesis to a terminal apparatus.

According to still another aspect of the present invention, there is provided a storage medium recording thereon a program enabling a computer to execute: processing to acquire from a server apparatus a document prepared in a first language; processing to separate the acquired document into a translation-needing portion and a non-translation-needing portion; processing to translate the translation-needing portion into a second language; processing to convert the non-translation-needing portion, where the portion contains information indicating that any word or phrase is to be delivered to the server apparatus, into a version of the portion appended with translating instruction information for recognizing the need to translate the word or phrase entered in the second language into the first language; and processing to synthesize the result of translation and that of conversion and supply the result of synthesis to a terminal apparatus.

### BRIEF DESCRIPTION OF THE DRAWINGS

Other features and advantages of the present invention will become more apparent from the detailed description hereunder when taken in conjunction with the accompanying drawings, wherein:

FIG. 1 is a block diagram illustrating the configuration of a translation server system, which is a first preferred embodiment of the invention;

FIG. 2 is a flow chart showing how the translation server system, which is the first preferred embodiment of the invention, operates;

FIG. 3 illustrates an example of translating instruction locational information;

FIG. 4 illustrates an example of displaying of a document designated by locational information on a browser without going through a translation server 10;

FIG. 5 illustrates an example of hyperlink document;

FIG. 6 illustrates an example of result of conversion by an information conversion unit 15;

FIG. 7 illustrates an example of displaying on a browser of the result of synthesis from an information synthesizing unit 16 to a terminal apparatus 20 in the first embodiment of the invention;

FIG. 8 illustrates an example of displaying on a browser of a state in which a user has filled blanks in the result of translation (FIG. 7) in the first embodiment of the invention;

FIG. 9 illustrates an example of displaying on a browser of a document of processed result not having gone through processing by the translation server 10 in the first embodiment of the invention;

FIG. 10 illustrates an example of displaying on a browser of the result of synthesis from the information synthesizing unit 16 to the terminal apparatus 20 with respect to the document of processed result (FIG. 9) in the first embodiment of the invention;

FIG. 11 illustrates the configuration of a translation server system, which is a second preferred embodiment of the invention;

FIG. 12 illustrates an example of displaying of a registration page prepared in English on a browser in the second preferred embodiment of the invention;

FIG. 13 illustrates an example of displaying of the registration page shown in FIG. 12 on a browser in the second preferred embodiment of the invention;

FIG. 14 illustrates an example of displaying of dialog boxes D20 through D24 in FIG. 13 filled with the user's personal information on a browser in the second preferred embodiment of the invention;

FIG. 15 illustrates an example of displaying of recorded contents in a recording server apparatus 40 on a browser in the second preferred embodiment of the invention;

FIG. 16 is a block diagram of the configuration of a translation server system according to the prior art.

### DETAILED DESCRIPTION OF THE PREFERRED EMBODIMENTS

Translation server systems, which are different preferred embodiments of the present invention will be described in detail below with reference to accompanying drawings.

[First Preferred Embodiment]

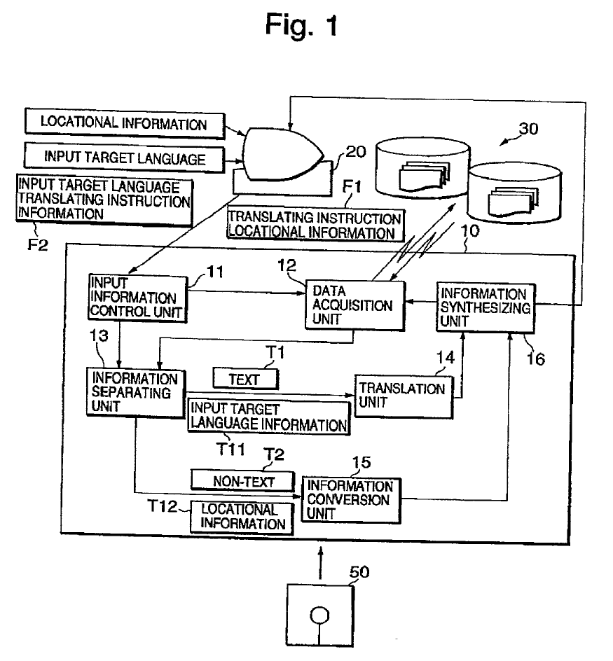

FIG. 1 is a block diagram illustrating the configuration of a translation server system, which is a first preferred embodiment of the invention. In FIG. 1, reference numeral 10 denotes a translation server; 20, a terminal apparatus such as a PC or a work station; and 30, a server apparatus in which hyperlink documents are stored. The translation server 10, the terminal apparatus 20 and the server apparatus 30 are connected via a network such as the Internet, In this embodiment, the functions of the translation server 10 may as well be realized by a program loaded from a storage medium 50 via a signal line. The storage medium 50 may be a magnetic disk, a semiconductor memory or any other suitable storage medium, and the program may be divided and each divided segment may be recorded on one or another of a plurality of grouped storage media.

The terminal apparatus 20 is mounted with a browsing program known as a browser to facilitate access to information, and supplies, at the instruction of the user, information F1 to instruct translation of a document identified by pertinent locational information (translating instruction locational information), locational information on an original language document and information entered in the language of the translated document (input target language information). The input target language information and the translating instruction information will be hereinafter together referred to as input target language translating instruction information, denoted with sign F2.

This embodiment is such a translation server system generate a document which, if the user who is the recipient, when operating the terminal apparatus 20 to translate and display a hyperlink document on a network, fills blanks in that document (form) with any word or phrase in the same language as that of the translated document (the target language), enables the server apparatus 30 to process that word or phrase in the original language of that document (the source language).

The translation server 10 consists of an input information control unit 11, a data acquisition unit 12, an information separating unit 13, a translation unit 14, an information conversion unit 15, and an information synthesizing unit 16. The input information control unit 11, when translating instruction locational information F1 has been transmitted from a browser provided on the terminal apparatus 20, supplies locational information in the translating instruction locational information F1 to the data acquisition unit 12. Or, when input target language translating instruction information F2 has been transmitted from the browser provided on the terminal apparatus 20, the input information control unit 11 supplies the information separating unit 13 with the already acquired locational information of the original document and the input target language translating instruction information F2 which has been newly transmitted.

The data acquisition unit 12 acquires from the server apparatus 30 the document identified by locational information supplied from the input information control unit 11, and supplies it to the information separating unit 13. It also acquires the input source language information and locational information supplied from the information synthesizing unit 16, instructs the server apparatus 30 to process to fill the blanks in a document specified by the acquired locational information with input source language information, acquires the document that is generated as a result (the document of processed result), and supplies it to the information separating unit 13.

The information separating unit 13 analyzes the document supplied from the data acquisition unit 12, separates it into a translation-needing text T1 and other information T2, and supplies the text T1 to the translation unit 14 and the non-text information T2 to the information conversion unit 15. If input target language translating instruction information is supplied from the input information control unit 11, the information separating unit 13 seperates it into input target language information T11 and locational information T12, and supplies the input target language information T11 to the translation unit 14 and the locational information T12 to the information conversion unit 15.

The translation unit 14 translates the translation-needing text portion in the hyperlink document from the source language to another language (the target language), and supplies the translated text to the information synthesizing unit 16. Or if input target language information T11 is supplied from the information separating unit 13, the translation unit 14 translates the input target language information T11 into the original language of the document (the source language), and supplies the translated information to the information synthesizing unit 16 as input source language information.

The information conversion unit 15 converts locational information (hyperlink) which associates a document contained in the non-text information T2 separated by the information separating unit 13 into translating instruction locational information, which is an instruction to translate a document designated by the locational information. This translating instruction locational information can be notified to the input information control unit 11 again as an instruction to translate a document. It also converts information regarding blanks contained in the non-text information T2 into translating instruction information that instructs translation of words or phrases entered into the blanks into the source language and processing of the translated words or phrases. Incidentally, locational information T12, if entered, is not processed.

The information synthesizing unit 16 synthesizes the output result of the translation unit 14 (translated text) and the output result of the information conversion unit 15 (non-text information containing translating instruction locational information), and supplies the resultant new hyperlink document (translated and converted document) to the terminal apparatus 20. It also synthesizes the input source language information supplied by the translation unit 14 and locational information supplied from the information separating unit 13 via the information conversion unit 15, and supplies the synthesized locational information and the input source language information to the data acquisition unit 12.

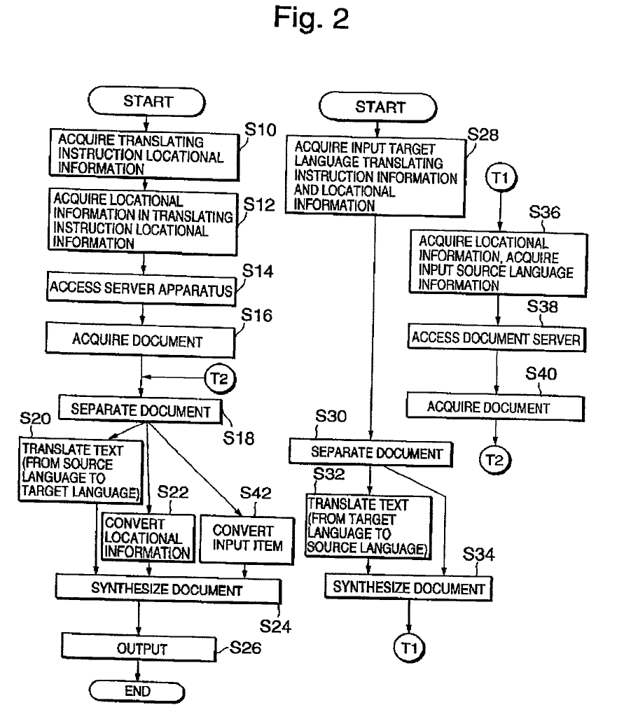

Next will be described the operation of the translation server system configured as described above, which is the first preferred embodiment of the present invention. FIG. 2 is a flow chart showing how the translation server system, which is the first embodiment of the invention, operates.

First, the user designates the URL of the translation server to the browser built into the terminal apparatus 20, and establishes connection to the translation server 10. Upon connection to the translation server 10, an input dialog box for entering the URL to be accessed and a dialog box for selecting the languages between which translation is to be done are displayed on the terminal apparatus 20. In this embodiment, for the sake of simplifying the description, a case in which the native language of the user of the terminal apparatus 20 is Japanese and that of the provider is English will be described.

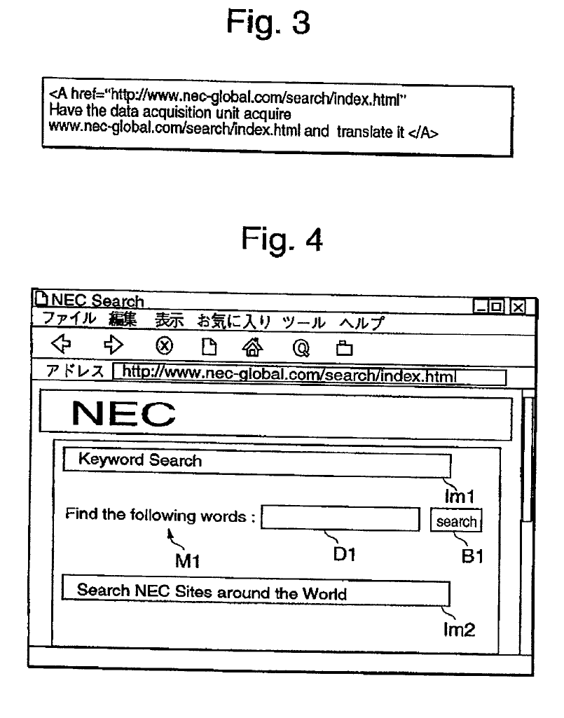

For instance, if the user enters “http://www.nec-global.com/search/index.html” into the input dialog box as the URL of the access destination, the translating instruction locational information F1 shown in FIG. 3 is transmitted from the terminal apparatus 20 to the translation server 10. FIG. 3 illustrates an example of translating instruction locational information. In FIG. 3, “www.nec-global.com/search/index.html” is the locational information contained in the translating instruction locational information, and “Have the data acquisition unit acquire www.nec-global.com/search/ index.html and translate it” is the translating instruction information contained in the translating instruction locational information. Incidentally, the translating instruction information shown in FIG. 3 is nothing more than an example, but any sign that can be recognized as translating instruction information by the server apparatus 10 can be used.

The input information control unit 11, upon acquiring the translating instruction locational information F1 transmitted from the terminal apparatus 20 (step S10), supplies the locational information contained in the translating instruction locational information F1 to the data acquisition unit 12. The data acquisition unit 12, upon acquiring the locational information (step S12), accesses via a network the server apparatus 30 in which the hyperlink document designated by this locational information is stored (step S14), and acquires the designated hyperlink document (step S16).

FIG. 4 illustrates an example of displaying of a document designated by the locational information on the browser without going through the translation server 10. As shown in FIG. 4, where the translation server 10 is not gone through, “Find the following words” is displayed in English on the browser as a message M1 for having a word or phrase entered in the blank to be filled of the document, an input dialog box D1 for entering a word or phrase is also displayed, and further a search button B1 to give an instruction to start searching according to the word or phrase entered in the dialog box D1 is displayed, too. Thus the hyperlink document displayed when the translation server 10 is not gone through is in the source language (English). Incidentally, the positions marked with Im1 and Im2 in FIG. 4, i.e. where “Keyword Search” and “Search NEC Sites around the World” are displayed in English, are where image data are displayed.

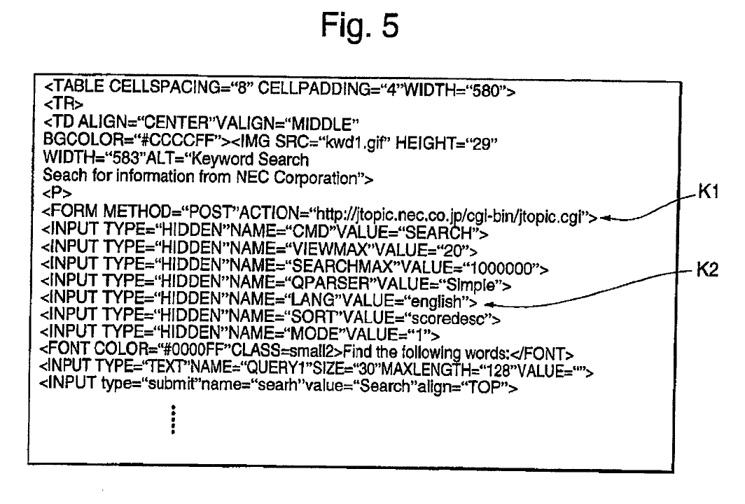

FIG. 5 illustrates an example of hyperlink document. As shown in FIG. 5, the hyperlink document contains the locational information K1 of the server apparatus 30 to be searched when data are entered into the input dialog box D1 shown in FIG. 4 and information K2 to designate the language of data used as a key of the search.

When the data acquisition unit 12 acquires the hyperlink document in the source language, the hyperlink document is supplied to the information separating unit 13. The information separating unit 13 analyzes the hyperlink document in the source language supplied from the data acquisition unit 12, and separates it into the translation-needing text T1 and the non-text information T2 (step S18). The text T1 mainly consists of characters to be displayed on the browser in English, while the non-text information T2 consists of tag information not to be displayed on the browser. The text T1 is supplied from the information separating unit 13 to the translation unit 14, while the non-text information T2 is supplied from the information separating unit 13 to the information conversion unit 15.

When the text T1 is entered into the translation unit 14, the translation unit 14 translates the entered text T1 (step S20). In this case, as the original of the text T1 is in English and the language into which it is to be translated is Japanese, the text is translated from English into Japanese. On the other hand, when the non-text information T2 is entered into the information conversion unit 15, the information conversion unit 15 converts locational information indicating the location of the hyperlink document, out of the non-text information T2, into information that can be notified again to the data acquisition unit 12 as translating instruction locational information F1 (step S22).

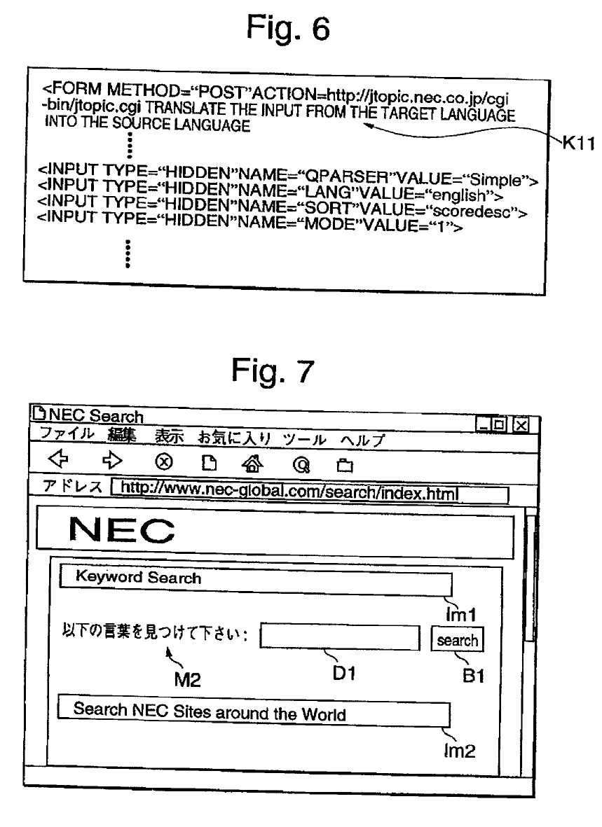

FIGS. 6 illustrates an example of result of conversion by an information conversion unit 15. Since the information K2 to designate the language in which blanks in the hyperlink document are to be filled is English, the words or phrases entered into these blanks should be in English when they are delivered to the server apparatus 30. As this embodiment allows the user of the terminal apparatus 20 to enter the words or phrases in his native language (e.g. Japanese), the entered words or phrases can not be delivered to the server apparatus 30 as they are. Therefore, translating instruction information for converting the words or phrases entered into the blanks in Japanese into English is added. As shown in FIG. 6, where the locational information K1 of the server apparatus 30 to be searched for with a word or phrase entered into a blank as the key is “jtopic.nec.co.jp/cgi-bin/jtopic.cgi”, the translating instruction information K11 for delivery to the server apparatus 30 designated by the locational information K1 is “Translate the input from the target language into the source language”. Incidentally the translating instruction information K11 shown in FIG. 6 is nothing more than an example, and any sign which the server apparatus 10 as translating instruction information can be used.

The result of translation of the text T1 by the translation unit 14 and the result of conversion of the non-text information T2 by the information conversion unit 15 are supplied to the information synthesizing unit 16. When these result of translation and result of conversion are entered, the information synthesizing unit 16 synthesizes them (step S24) . The result of synthesis by the information synthesizing unit 16 is supplied to the terminal apparatus 20 (step S26). FIG. 7 illustrates an example of displaying on the browser of the result of synthesis from the information synthesizing unit 16 to the terminal apparatus 20. The Japanese sentence indicated with M2 in FIG. 7 is a Japanese version of the English message “Find the following words” in FIG. 4. Incidentally, as in FIG. 4, the input dialog box D1 to enter a word or phrase and the search button B1 to give an instruction to start searching are also displayed. The sequence of processing, which is accomplished by the translation server 10 when the user has entered locational information into the terminal apparatus 20, is now completed.

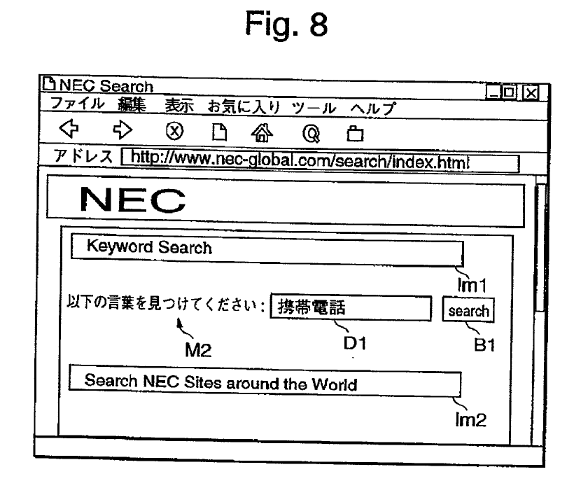

Next will be described the processing that takes place when the user has entered a word or phrase into a blank in the document displayed on the terminal apparatus 20. It is supposed here that, when the display on the browser of the terminal apparatus 20 is in the state shown in FIG. 7, the user enters the word or phrase into the input dialog box D1 in Japanese as shown in FIG. 8. In FIG. 8, a Japanese word meaning “mobile phone” has been entered, and this phrase is displayed in the input dialog box D1. When the user presses the search button B1 in this state, input target language translating instruction information F2 is transmitted from the terminal apparatus 20 to the translation server. Incidentally, input target language information in the input target language translating instruction information F2 is a Japanese phrase entered by the user (input target language), and the translating instruction information is information to instruct translation of this input target language into the input source language. Thus it is “Translate the input from the target language into the source language” shown in FIG. 6.

The input information control unit 11, upon acquiring locational information and input target language translating instruction information F2 transmitted from the terminal apparatus 20 (step S28), supplies the input target language information in the input target language translating instruction information F2 and locational information (locational information K1 in FIG. 5) to the information separating unit 13. To add, although illustration is dispensed with, locational information is transmitted together with input target language translating instruction information F2 in the configuration of FIG. 1. The information separating unit 13, upon acquiring the input target language information and the locational information, separates them into the input target language information and the locational information (step S30), and supplies the input target language information to the translation unit 14 and the locational information to the information conversion unit 15.

The translation unit 14, upon acquiring the input target language information, translates it into the input source language information. Thus, when the Japanese words shown in FIG. 8 have been transmitted from the terminal apparatus 20, it translate these words (input target language information) into words in English, which is the source language (the input source language information), i.e. into “mobile phone” (step S32). The result of translation by the translation unit 14, i.e. the input source language information, is supplied to the information synthesizing unit 16. On the other hand, the information conversion unit 15, if it acquires the locational information, subjects the locational information to no conversion processing and supplies it to the information synthesizing unit 16.

The information synthesizing unit 16 synthesizes the input source language information supplied from the translation unit 14 and the locational information supplied from the information conversion unit 15 (step S34), and supplies the result of synthesis to the data acquisition unit 12. The data acquisition unit 12, upon acquiring the result of synthesis consisting of the input source language information supplied from the information synthesizing unit 16 and the locational information (step S36), accesses the designated server apparatus 30 according to the locational information (step S38), delivers the input source language information as information entered into a blank, and acquires a document newly generated as a result of processing of the input source language information by the document server (document of processed result) (step S40).

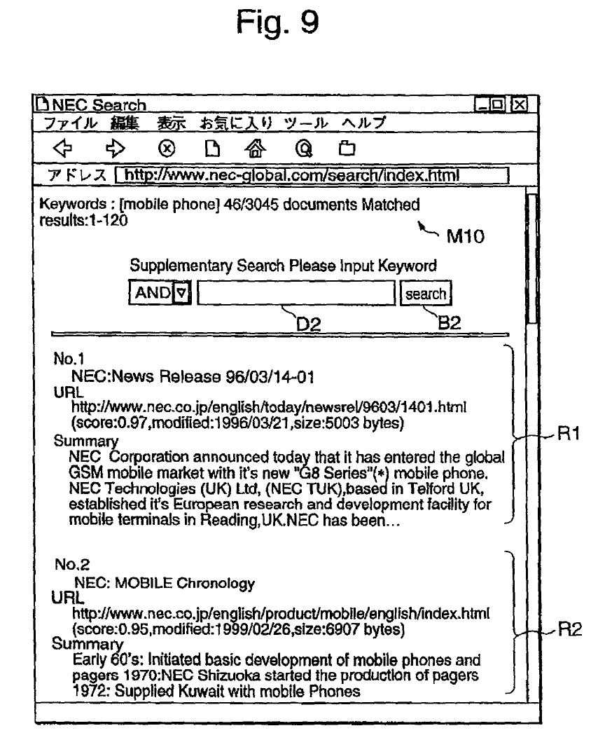

FIG. 9 illustrates an example of displaying on the browser of the document of processed result not having gone through processing by the translation server 10 in the first embodiment of the invention. As shown in FIG. 9, the document of processed result is a document prepared in the source language (English), displaying a result of search M10 indicating that “mobile phone”, which is the input source language information, was contained in 46 items out of 3045, an input dialog box D2 for narrowed-down search, a search button B2, a summary R1 of a first result of search, and a summary R2 of a second result of search among others.

In this embodiment, for the translation of a document of processed result written in English as shown FIG. 9, the document of processed result is again supplied to the information separating unit 13. Thus, the data acquisition unit 12, upon acquiring a document of processed result, supplies the document of processed result to the information separating unit 13. The information separating unit 13 analyzes the original document of processed result supplied from the data acquisition unit 12, and separates it into the translation-needing text T1 and the non-text information T2 (step S18). The text T1 is supplied from the information separating unit 13 to the translation unit 14, while the non-text information T2 is supplied from the information separating unit 13 to the information conversion unit 15.

When the text T1 is entered into the translation unit 14, the translation unit 14 translates the entered text T1. If there is any blank to fill, it is made an input item with a translating instruction (step S42). In this case, as the original of the text T1 is in English and its target language is Japanese, the text is translated from English into Japanese. On the other hand, upon entry of the non-text information T2 into the information conversion unit 15, the information conversion unit 15 converts information concerning a hyperlink document, out of the non-text information T2, into information that can be again notified to the data acquisition unit 12 as the translating instruction locational information F1 (step S22).

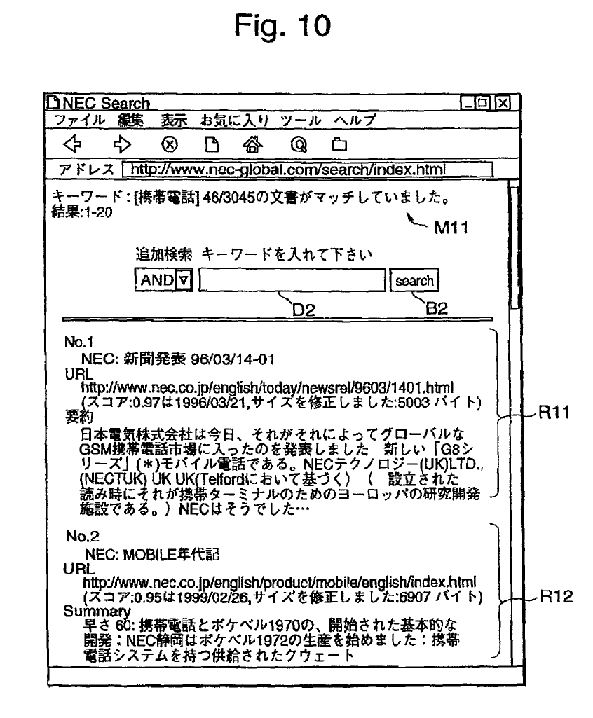

The result of translation of the text T1 by the translation unit 14 and the result of conversion of the non-text information T2 by the information conversion unit 15 are supplied to the information synthesizing unit 16. Upon entry of these result of translation and result of conversion, the information synthesizing unit 16 synthesize them (step S24). The result of synthesis by the information synthesizing unit 16 is supplied to the terminal apparatus 20 (step S26). FIG. 10 illustrates an example of displaying on the browser of the result of synthesis from the information synthesizing unit 16 to the terminal apparatus 20. The result of search M10 and the summaries R1 and R2 in English in FIG. 9 are translated into Japanese, and displayed as the result of search M10 and the summaries R1 and R2 in FIG. 10. If there is any blank to fill, it is made an input item with a translating instruction. The sequence of processing, which is accomplished by the translation server 10 when the user has entered the input target language into the terminal apparatus 20, is now completed.

[Second Preferred Embodiment]

Next will be described a translation server system, which is a second preferred embodiment of the present invention. The translation server system, embodying the invention in this mode, solves the problem that, where the recipient (the user) is to transmit personal information of the like to a provider, for instance a form for hotel or ticket booking is prepared in English and its contents are translated into Japanese by the translation server and displayed in the translated version, answering each entry in the form in Japanese would make it impossible for the hotel's clerk, whose native language is English, to understand the filled form. To add, this embodiment is not limited to use in hotel booking, but can be generally applied to cases where the user is to transmission to some other party whose native language is different from the user's.

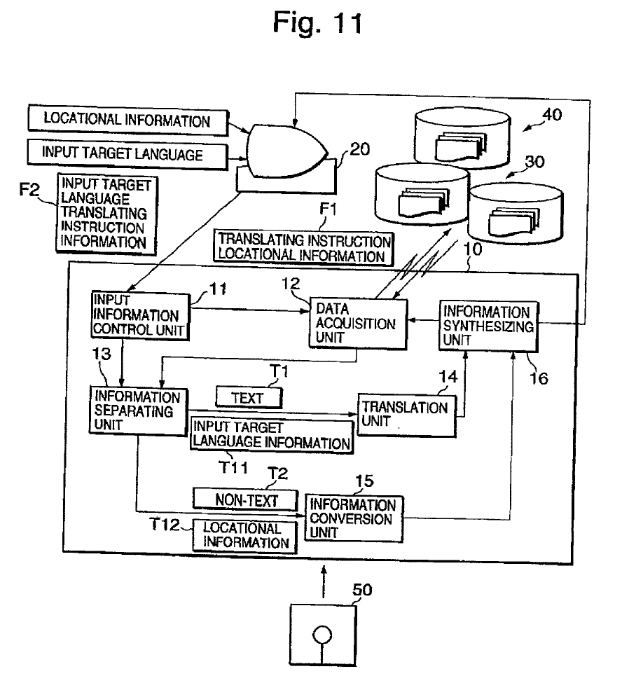

FIG. 11 illustrates the configuration of a translation server system, which is the second preferred embodiment of the invention, wherein the same constituent elements as in the first embodiment of the invention illustrated in FIG. 1 are assigned respectively the same signs, whose illustration is dispensed with here. The translation server system shown in FIG. 11, which is the second embodiment of the invention, differs from the first embodiment shown in FIG. 1 in that a recording server apparatus 40 for the provider to record information transmitted from the recipient (the user) is provided. The operation of the translation server 10 is the same as in the first embodiment.

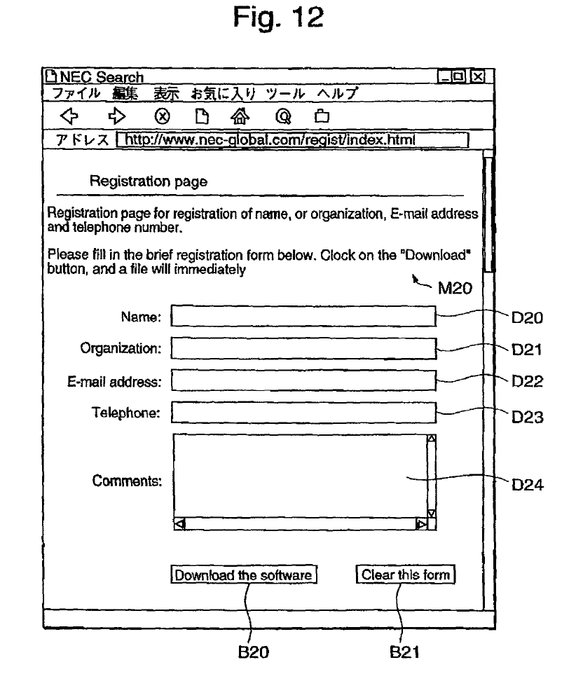

Here is supposed a case in which, where the user is to access a home page and download some software, his personal information is to be registered. It is further supposed that the URL of this home page is “http://www.nec-global.com/ regsit/index.html” and its contents are displayed, unless the translation server 10 is gone through, in English as shown in FIG. 12. FIG. 12 illustrates an example of displaying of a registration page prepared in English on the browser. The registration page shown in FIG. 12 displays a message M20 prepared in English, having five blanks to fill under the headings of “Name”, “Organization”, “E-mail address”, “Telephone” and “Comments”, respectively provided with entry dialog boxes D20 through D24. The page is further provided with a button B20 for transmitting to the provider the contents entered into the input dialog boxes D20 through D24 and downloading some software and a button B21 for deleting the contents entered into the input dialog boxes D20 through D24.

First, the user designates the URL of the translation server 10 to the browser built into the terminal apparatus 20, and establishes connection to the translation server 10. Upon establishment of connection to the translation server 10, an input dialog box for entering the URL to be accessed is displayed on the terminal apparatus 20, and a dialog box for selecting the languages between which translation is to be done is also displayed. Hereupon, as the user enters “http://www.nec-global.com/regist/index.html” into the input dialog box as the URL of the access destination and transmits it to the translation server 10, the translation server 10 translates the registration page prepared in English as shown in FIG. 12, and supplies the translated contents to the terminal apparatus 20.

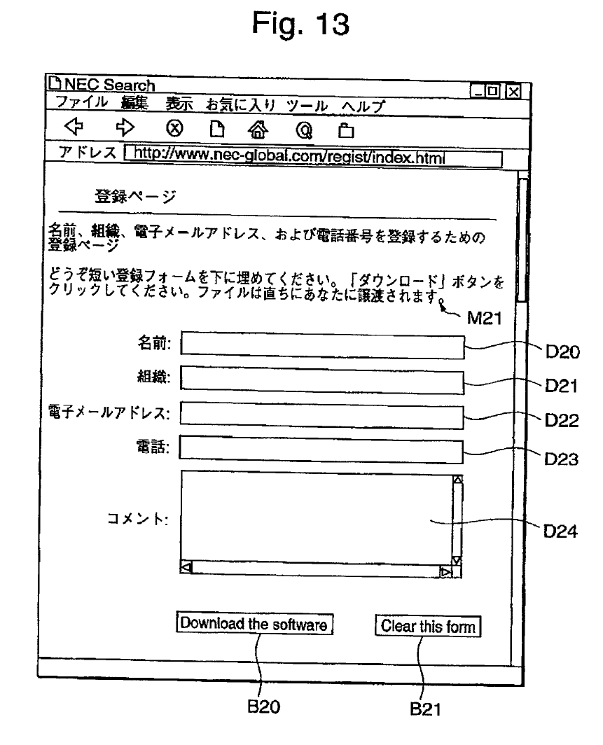

FIG. 13 illustrates an example of displaying of the registration page shown in FIG. 12 on the browser. As shown in FIG. 13, the message M20 in English in FIG. 12 is translated into a message M21 in Japanese, and the headings of five blanks for “Name”, “Organization”, “E-mail address”, “Telephone” and “Comments” are translated into their respective Japanese equivalents.

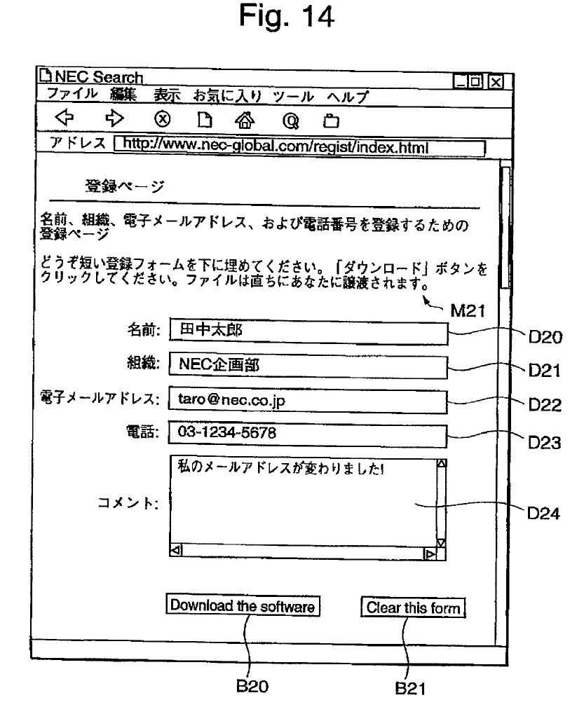

When, in a state in which the contents shown in FIG. 13 are displayed, the user enters his name into the input dialog box D20, the name of the organization he belongs to into the input dialog box D21, his E-mail address into the input dialog box D22, his telephone number into the input dialog box D23 and a comment into the input dialog box D24, the contents displayed on the browser will become as shown in FIG. 14. FIG. 14 illustrates an example of displaying of dialog boxes D20 through D24 in FIG. 13 filled with the user's personal information on the browser.

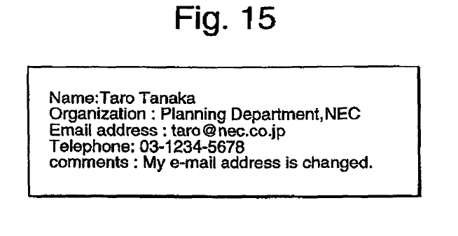

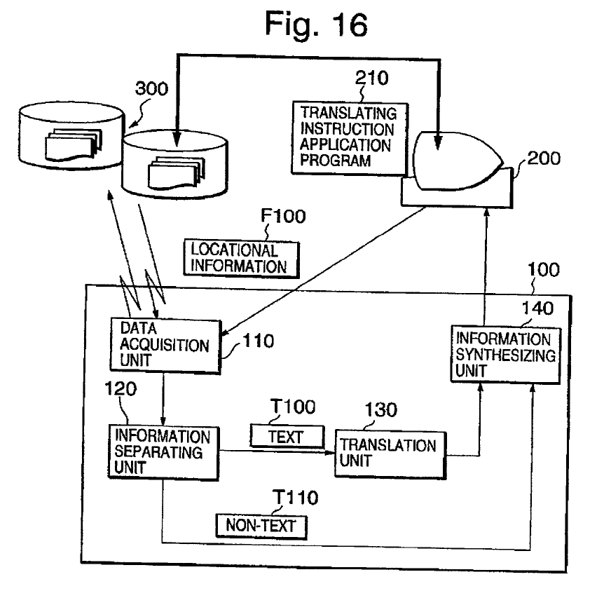

As the user presses the button B20 in the state illustrated in FIG. 14, the words or phrases entered into the input dialog boxes D20 through D24 are transmitted from the terminal apparatus 20 to the translation server 10 as the input target language information contained in the input target language translating instruction information F2. Upon acquisition of the input target language translating instruction information F2 by the input information control unit 11, the input target language information consisting of these words or phrases are translated by the translation unit 14 via the data acquisition unit 12 and the information separating unit 13 into “Taro Tanaka”, “Planning Department, NEC”, “taro@nec.co.jp”, “03-1234-5678” and “My E-mail address is changed”. The translated entries are delivered to a document server via the information synthesizing unit 15 and the data acquisition unit 12, and supplied by a program there to the recording server apparatus 40 to be recorded. FIG. 15 illustrates an example of displaying of recorded contents in the recording server apparatus 40 on the browser. What deserves note here is that, though the user entered the information in Japanese, the recording server apparatus 40 records the information in English. Therefore, the user can fill the blanks with pertinent information in his native language, the provider can also reference in his own native language the information recorded in the recording server apparatus 40.

As hitherto described, according to the present invention, since a hyperlink document prepared in the source language is translated into the target language and displayed on the terminal apparatus, and even if the recipient enters information in the target language the translation unit translates that information into the source language, there is afforded an advantage of minimizing the troublesome handling on the part of the recipient.

Furthermore, for the server apparatus responsible for searching, there is another advantage that the information is delivered in the source language and accordingly the searching can be accomplished properly.

Moreover, where information sent by the recipient is to be recorded into the recording server apparatus, as that information is recorded after being translated into the source language, there is still another advantage that the information sent by the recipient can be utilized by another party whose native language is different from the recipient's.

Thus, by having information transmitted and received via the translation server system, there is provided the convenience that the recipient and the provider can exchange information in their respective native languages.

Furthermore, the recipient is not required to enter information only after translating it and can enter it in his native language, and the communication cost can be saved by restraining unnecessary communication

What is claimed is:

1. An apparatus for translating documents, comprising:
a data acquisition unit for acquiring from a server apparatus a document prepared in a first language;
an information separating unit for separating the document acquired by said data acquisition unit into a translation-needing portion and a non-translation-needing portion;
a translation unit for translating the translation-needing portion obtained by said information separating unit into a second language;
an information conversion unit for converting the non-translation-needing portion obtained by said information separating unit, where the portion contains information indicating that any word or phrase is to be delivered to said server apparatus, into a version of the portion appended with translating instruction information for recognizing the need to translate the word or phrase entered in said second language into said first language; and
an information synthesizing unit for synthesizing the result of translation by said translation unit and that of conversion by said information conversion unit and supplying the result of synthesis to a terminal apparatus.

2. The apparatus, as claimed in claim 1, wherein:
information for delivering said word or phrase to said server apparatus is the locational information of said server apparatus, and said information conversion unit adds said translating instruction information to this locational information.

3. The apparatus, as claimed in claim 2, wherein:
said translation unit translates a word or phrase entered in said second language into said first language, and delivers the result of translation to a server apparatus identified by said locational information.

4. A method for translating documents, comprising:
acquiring a document prepared in a first language from a server apparatus;
separating said acquired document into a translation-needing portion and a non-translation-needing portion;
translating said translation-needing portion into a second language;
converting said non-translation-needing portion, where the portion contains information indicating that any word or phrase is to be delivered to said server apparatus, into a version of the portion appended with translating instruction information for recognizing the need to translate the word or phrase entered in said second language into said first language; and
synthesizing the result of said translation and that of said conversion and supplying the result of synthesis to a terminal apparatus.

5. The method, as claimed in claim 4, wherein:
information for delivering said word or phrase to said server apparatus is the locational information of said server apparatus, and said translating instruction information is added to this locational information in said conversion processing.

6. The method, as claimed in claim 5, further including:
translating a word or phrase entered in said second language into said first language, and delivering the result of translation to a server apparatus identified by said locational information.

7. A storage medium recording thereon a program enabling a computer to execute:
processing to acquire from a server apparatus a document prepared in a first language;
processing to separate said acquired document into a translation-needing portion and a non-translation-needing portion;
processing to translate said translation-needing portion into a second language;
processing to convert said non-translation-needing portion, where the portion contains information indicating that any word or phrase is to be delivered to said server apparatus, into a version of the portion appended with translating instruction information for recognizing the need to translate the word or phrase entered in said second language into said first language; and
processing to synthesize the result of said translation and that of said conversion and supply the result of synthesis to a terminal apparatus.

8. The storage medium, as claimed in claim 7, wherein:
information for delivering said word or phrase to said server apparatus is the locational information of said server apparatus, and said program, in said conversion processing, adds said translating instruction information to this locational information.

9. The storage medium, as claimed in claim 8, wherein;
said program causes a computer to translate a word or phrase entered in said second language into said first language, and execute the processing to deliver the result of translation to a server apparatus identified by said locational information.

10. A plurality of grouped storage media in which said program claimed in claim 7 is divided and each divided segment is recorded on one or another of said plurality of storage media.

11. A program embodied in electrical signals, said program enabling a computer to execute:
processing to acquire from a server apparatus a document prepared in a first language;
processing to separate said acquired document into a translation-needing portion and a non-translation-needing portion;
processing to translate said translation-needing portion into a second language;
processing to convert said non-translation-needing portion, where the portion contains information indicating that any word or phrase is to be delivered to said server apparatus, into a version of the portion appended with translating instruction information for recognizing the need to translate the word or phrase entered in said second language into said first language; and
processing to synthesize the result of said translation and that of said conversion and supply the result of synthesis to a terminal apparatus.

12. The program as claimed in claim 11, wherein:
information for delivering said word or phrase to said server apparatus is the locational information of said server apparatus, and said program, in said conversion processing, adds said translating instruction information to this locational information.

13. The program as claimed in claim 12, said program further enabling a computer to execute the processing to translate a word or phrase entered in said second language into said first language, and deliver the result of translation to a server apparatus identified by said locational information.
